(19) United States
(12) Patent Application Publication
(10) Pub. No.: US 2024/0378998 A1
(43) Pub. Date: Nov. 14, 2024

(54) METHOD, APPARATUS, AND COMPUTER PROGRAM PRODUCT FOR DEFINING A GEO-DEFENSE AREA RELATED TO PRESENCE OF A ROADWORKER ENTITY

(71) Applicant: HERE GLOBAL B.V., Eindhoven (NL)

(72) Inventors: Jingwei Xu, Buffalo Grove, IL (US); Bruce Bernhardt, Wauconda, IL (US); Weimin Huang, Summit, NJ (US); Yuxin Guan, Chicago, IL (US)

(21) Appl. No.: 18/314,416

(22) Filed: May 9, 2023

(51) Int. Cl. G08G 1/0967; G08G 1/01; G08G 1/16

(52) U.S. Cl. CPC G08G 1/096725; G08G 1/0112; G08G 1/0133; G08G 1/0141; G08G 1/166

(57) ABSTRACT

A method, apparatus and computer program product are provided for defining a geo-defense area related to presence of a roadworker entity. In this regard, a roadwork event related to a roadwork zone region of a road segment is identified based at least in part on one or more probe apparatuses traveling along the road segment. Furthermore, presence of at least one roadworker entity within the roadwork zone region is detected based at least in part on sensor data from the one or more probe apparatuses. Based at least on part on map data related to the roadwork zone region and location data related to the roadworker entity, a geo-defense area related to the roadworker entity is defined. Additionally, an indication of the geo-defense area is provided to one or more autonomous vehicles to facilitate navigation of the one or more autonomous vehicles along the road segment.

### TECHNOLOGICAL FIELD

An example embodiment of the present disclosure generally relates to autonomous driving for vehicles and, more particularly, to a method, apparatus and computer program product for defining a geo-defense area related to presence of a roadworker entity.

### BACKGROUND

Vehicles are being built with more and more sensors to assist with autonomous driving and/or other vehicle technologies. Generally, sensors of a vehicle related to autonomous driving capture imagery data and/or radar data to assist with the autonomous driving. For instance, image sensors and Light Distancing and Ranging (LiDAR) sensors are popular sensor types for identifying objects along a road segment and/or establishing the safe path of traversal for a vehicle driving autonomously. Autonomous driving capabilities of vehicles are increasing toward full automation (e.g., Level 5 autonomy) with zero human interaction. However, there are numerous challenges related to autonomous driving capabilities of vehicles.

### BRIEF SUMMARY

A method, apparatus and computer program product are provided in order to provide for defining a geo-defense area related to presence of a roadworker entity. As such, improved navigation of a vehicle, improved route guidance for a vehicle, improved semi-autonomous vehicle control, and/or improved fully autonomous vehicle control can also be provided.

In an example, embodiment, a computer-implemented method is provided. The computer-implemented method includes identifying a roadwork event related to a roadwork zone region of a road segment based at least in part on one or more probe apparatuses traveling along the road segment. In one or more embodiments, the computer-implemented method also includes detecting presence of at least one roadworker entity within the roadwork zone region based at least in part on sensor data from the one or more probe apparatuses. In one or more embodiments, the computer-implemented method also includes defining a geo-defense area related to the roadworker entity based at least on part on map data related to the roadwork zone region and location data related to the roadworker entity. In one or more embodiments, the computer-implemented method also includes providing an indication of the geo-defense area to one or more autonomous vehicles to facilitate navigation of the one or more autonomous vehicles along the road segment.

In one or more embodiments, identifying the roadwork event includes identifying the roadwork event based at least in part on road condition data related to the road segment. In one or more embodiments, identifying the roadwork event additionally or alternatively includes identifying the roadwork event based at least in part on traffic incident data related to the road segment. In one or more embodiments, identifying the roadwork event additionally or alternatively includes identifying the roadwork event based at least in part on hazard warning data related to the road segment. In one or more embodiments, identifying the roadwork event additionally or alternatively includes identifying the roadwork event based at least in part on weather condition data related to the road segment. In one or more embodiments, identifying the roadwork event additionally or alternatively includes identifying the roadwork event based at least in part on high-definition (HD) map data related to the road segment.

In one or more embodiments, defining the geo-defense area includes defining a geometry for the geo-defense area based at least on part on the map data related to the roadwork zone region and the location data related to the roadworker entity. In one or more embodiments, defining the geo-defense area additionally or alternatively includes defining a speed profile for the geo-defense area based at least on part on the map data related to the roadwork zone region and the location data related to the roadworker entity. In one or more embodiments, defining the geo-defense area additionally or alternatively includes defining speed limit information for the geo-defense area based at least on part on the map data related to the roadwork zone region and the location data related to the roadworker entity.

In one or more embodiments, the computer-implemented method additionally or alternatively includes generating a notification for the one or more autonomous vehicles based at least in part on the geo-defense area. In one or more embodiments, the computer-implemented method additionally or alternatively includes determining a navigation route along the road segment for the one or more autonomous vehicles based at least in part on the geo-defense area. In one or more embodiments, the computer-implemented method additionally or alternatively includes configuring an autonomous driving level for the one or more autonomous vehicles based at least in part on the geo-defense area.

In another example embodiment, an apparatus includes processing circuitry and at least one memory including computer program code instructions that are configured to, when executed by the processing circuitry, cause the apparatus to identify a roadwork event related to a roadwork zone region of a road segment based at least in part on one or more probe apparatuses traveling along the road segment. In one or more embodiments, the computer program code instructions are also configured to, when executed by the processing circuitry, cause the apparatus to detect presence of at least one roadworker entity within the roadwork zone region based at least in part on sensor data from the one or more probe apparatuses. In one or more embodiments, the computer program code instructions are also configured to, when executed by the processing circuitry, cause the apparatus to define a geo-defense area related to the roadworker entity based at least on part on map data related to the roadwork zone region and location data related to the roadworker entity. In one or more embodiments, the computer program code instructions are also configured to, when executed by the processing circuitry, cause the apparatus to provide an indication of the geo-defense area to one or more autonomous vehicles to facilitate navigation of the one or more autonomous vehicles along the road segment.

In one or more embodiments, the computer program code instructions are additionally or alternatively configured to, when executed by the processing circuitry, cause the apparatus to identify the roadwork event based at least in part on road condition data related to the road segment. In one or more embodiments, the computer program code instructions are additionally or alternatively configured to, when executed by the processing circuitry, cause the apparatus to identify the roadwork event based at least in part on traffic incident data related to the road segment. In one or more embodiments, the computer program code instructions are additionally or alternatively configured to, when executed by the processing circuitry, cause the apparatus to identify the roadwork event based at least in part on hazard warning data related to the road segment. In one or more embodiments, the computer program code instructions are additionally or alternatively configured to, when executed by the processing circuitry, cause the apparatus to identify the roadwork event based at least in part on weather condition data related to the road segment. In one or more embodiments, the computer program code instructions are additionally or alternatively configured to, when executed by the processing circuitry, cause the apparatus to identify the roadwork event based at least in part on HD map data related to the road segment.

In one or more embodiments, the computer program code instructions are additionally or alternatively configured to, when executed by the processing circuitry, cause the apparatus to define a geometry for the geo-defense area based at least on part on the map data related to the roadwork zone region and the location data related to the roadworker entity. In one or more embodiments, the computer program code instructions are additionally or alternatively configured to, when executed by the processing circuitry, cause the apparatus to define a speed profile for the geo-defense area based at least on part on the map data related to the roadwork zone region and the location data related to the roadworker entity. In one or more embodiments, the computer program code instructions are additionally or alternatively configured to, when executed by the processing circuitry, cause the apparatus to define speed limit information for the geo-defense area based at least on part on the map data related to the roadwork zone region and the location data related to the roadworker entity.

In one or more embodiments, the computer program code instructions are additionally or alternatively configured to, when executed by the processing circuitry, cause the apparatus to generate a notification for the one or more autonomous vehicles based at least in part on the geo-defense area. In one or more embodiments, the computer program code instructions are additionally or alternatively configured to, when executed by the processing circuitry, cause the apparatus to determine a navigation route along the road segment for the one or more autonomous vehicles based at least in part on the geo-defense area. In one or more embodiments, the computer program code instructions are additionally or alternatively configured to, when executed by the processing circuitry, cause the apparatus to configure an autonomous driving level for the one or more autonomous vehicles based at least in part on the geo-defense area.

In another example embodiment, a computer program product is provided. In one or more embodiments, the computer program product includes at least one computer readable storage medium having computer-executable program code instructions stored therein with the computer-executable program code instructions including program code instructions. In some embodiments, the computer readable storage medium is a non-transitory computer readable storage medium. In one or more embodiments, the computer-executable program code instructions are configured, upon execution, to identify a roadwork event related to a roadwork zone region of a road segment based at least in part on one or more probe apparatuses traveling along the road segment. In one or more embodiments, the computer-executable program code instructions are also configured, upon execution, to detect presence of at least one roadworker entity within the roadwork zone region based at least in part on sensor data from the one or more probe apparatuses. In one or more embodiments, the computer-executable program code instructions are also configured, upon execution, to define a geo-defense area related to the roadworker entity based at least on part on map data related to the roadwork zone region and location data related to the roadworker entity. In one or more embodiments, the computer-executable program code instructions are also configured, upon execution, to provide an indication of the geo-defense area to one or more autonomous vehicles to facilitate navigation of the one or more autonomous vehicles along the road segment.

In one or more embodiments, the computer-executable program code instructions are additionally or alternatively configured to identify the roadwork event based at least in part on road condition data related to the road segment. In one or more embodiments, the computer-executable program code instructions are additionally or alternatively configured to identify the roadwork event based at least in part on traffic incident data related to the road segment. In one or more embodiments, the computer-executable program code instructions are additionally or alternatively configured to identify the roadwork event based at least in part on hazard warning data related to the road segment. In one or more embodiments, the computer-executable program code instructions are additionally or alternatively configured to identify the roadwork event based at least in part on weather condition data related to the road segment. In one or more embodiments, the computer-executable program code instructions are additionally or alternatively configured to identify the roadwork event based at least in part on HD map data related to the road segment.

In one or more embodiments, the computer-executable program code instructions are additionally or alternatively configured to define a geometry for the geo-defense area based at least on part on the map data related to the roadwork zone region and the location data related to the roadworker entity. In one or more embodiments, the computer-executable program code instructions are additionally or alternatively configured to define a speed profile for the geo-defense area based at least on part on the map data related to the roadwork zone region and the location data related to the roadworker entity. In one or more embodiments, the computer-executable program code instructions are additionally or alternatively configured to define speed limit information for the geo-defense area based at least on part on the map data related to the roadwork zone region and the location data related to the roadworker entity.

In one or more embodiments, the computer-executable program code instructions are additionally or alternatively configured to generate a notification for the one or more autonomous vehicles based at least in part on the geo-defense area. In one or more embodiments, the computer-executable program code instructions are additionally or alternatively configured to determine a navigation route along the road segment for the one or more autonomous vehicles based at least in part on the geo-defense area. In one or more embodiments, the computer-executable program code instructions are additionally or alternatively configured to configure an autonomous driving level for the one or more autonomous vehicles based at least in part on the geo-defense area.

In yet another example embodiment, an apparatus is provided that includes means for identifying a roadwork event related to a roadwork zone region of a road segment based at least in part on one or more probe apparatuses traveling along the road segment. In one or more embodiments, the apparatus of this example embodiment also includes means for detecting presence of at least one roadworker entity within the roadwork zone region based at least in part on sensor data from the one or more probe apparatuses. In one or more embodiments, the apparatus of this example embodiment also includes means for defining a geo-defense area related to the roadworker entity based at least on part on map data related to the roadwork zone region and location data related to the roadworker entity. In one or more embodiments, the apparatus of this example embodiment also includes means for providing an indication of the geo-defense area to one or more autonomous vehicles to facilitate navigation of the one or more autonomous vehicles along the road segment.

In one or more embodiments, means for identifying the roadwork event includes means for identifying the roadwork event based at least in part on road condition data related to the road segment. In one or more embodiments, means for identifying the roadwork event additionally or alternatively includes means for identifying the roadwork event based at least in part on traffic incident data related to the road segment. In one or more embodiments, means for identifying the roadwork event additionally or alternatively includes means for identifying the roadwork event based at least in part on hazard warning data related to the road segment. In one or more embodiments, means for identifying the roadwork event additionally or alternatively includes means for identifying the roadwork event based at least in part on weather condition data related to the road segment. In one or more embodiments, means for identifying the roadwork event additionally or alternatively includes means for identifying the roadwork event based at least in part on HD map data related to the road segment.

In one or more embodiments, means for defining the geo-defense area includes means for defining a geometry for the geo-defense area based at least on part on the map data related to the roadwork zone region and the location data related to the roadworker entity. In one or more embodiments, means for defining the geo-defense area additionally or alternatively includes means for defining a speed profile for the geo-defense area based at least on part on the map data related to the roadwork zone region and the location data related to the roadworker entity. In one or more embodiments, means for defining the geo-defense area additionally or alternatively includes means for defining speed limit information for the geo-defense area based at least on part on the map data related to the roadwork zone region and the location data related to the roadworker entity.

In one or more embodiments, the apparatus of this example embodiment additionally or alternatively includes means for generating a notification for the one or more autonomous vehicles based at least in part on the geo-defense area. In one or more embodiments, the apparatus of this example embodiment additionally or alternatively includes means for determining a navigation route along the road segment for the one or more autonomous vehicles based at least in part on the geo-defense area. In one or more embodiments, the apparatus of this example embodiment additionally or alternatively includes means for configuring an autonomous driving level for the one or more autonomous vehicles based at least in part on the geo-defense area.

### BRIEF DESCRIPTION OF THE DRAWINGS

Having thus described certain embodiments of the disclosure in general terms, reference will now be made to the accompanying drawings, which are not necessarily drawn to scale, and wherein:

FIG. 1 is a block diagram of a system including an apparatus for defining a geo-defense area related to presence of a roadworker entity in accordance with one or more example embodiments of the present disclosure;

FIG. 2 is a flowchart illustrating operations performed, such as by the apparatus of FIG. 1, in order to provide for defining a geo-defense area related to presence of a roadworker entity in accordance with one or more example embodiments of the present disclosure;

FIG. 3 illustrates a system that includes a vehicle and the apparatus of FIG. 1 in accordance with one or more example embodiments of the present disclosure;

FIG. 4 illustrates an example geo-defense area generation process in accordance with one or more example embodiments of the present disclosure;

FIG. 5 is a block diagram of a system that facilitates generation of map data in accordance with one or more example embodiments of the present disclosure; and

FIG. 6 is an example embodiment of an architecture specifically configured for implementing embodiments described herein.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure can be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms can be used interchangeably to refer to data capable of being transmitted, received and/or stored in accordance with embodiments of the present disclosure. Thus, use of any such terms should not be taken to limit the spirit and scope of embodiments of the present disclosure.

An autonomous vehicle may utilize sensor technologies to assist with navigation of the autonomous vehicle along a road segment. For example, an autonomous vehicle may utilize sensor data associated with the autonomous vehicle to assist with autonomous driving decisions provided by an engine control module (ECM), an electronic control unit (ECU), an Advanced Driver Assistance System (ADAS), and/or another system of the autonomous vehicle. An autonomous driving decision can be related to a change in an autonomous driving mode for an autonomous vehicle. In one example, an autonomous driving decision can include engaging an autonomous driving mode from a non-autonomous driving mode (e.g., a manual driving mode or a half-autonomous driving mode). In another example, an autonomous driving decision can include disengaging an autonomous driving mode to a non-autonomous driving mode. However, a change in an autonomous driving mode for an autonomous vehicle can result from various factors such as, but not limited to, weather changes, changes between location environmental information and map content, changes in road geometry or other road segment conditions, changes in traffic conditions, changes in wireless network data capable of supporting autonomous driving, and road construction events related to a road segment, etc. Generally, sensors of an autonomous vehicle capture sensor data to assist with the autonomous driving. For instance, camera sensors, Light Distancing and Ranging (LiDAR) sensors, radar sensors, geolocation sensors, ultrasonic sensors, and other in-vehicle sensors are exemplary sensor types for identifying objects along a road segment and/or establishing a safe path of traversal for an autonomous vehicle driving autonomously.

Autonomous driving modes may be defined by various autonomous driving levels such as, for example, Level 0 that corresponds to no automation, Level 1 that corresponds to driver assistance, Level 2 that corresponds to partial automation, Level 3 that corresponds to conditional automation, Level 4 that corresponds to high automation, Level 5 that corresponds to full automation, and/or another sub-level associated with a degree of autonomous driving. Autonomous driving capabilities of autonomous vehicles are increasing toward full automation (e.g., Level 5 autonomy) with zero human interaction. However, there are numerous challenges related to autonomous driving capabilities of autonomous vehicles. For example, work zone information for a road segment can be delivered as incident feeds to autonomous vehicles for navigation and/or route planning. However, roadworker entities such as, for example, construction workers, management personnel, field safety workers, or other roadworkers are often vulnerable to an incident with a vehicle such as, for example, an autonomous vehicle during a dynamic construction event associated with a road segment. As such, for certain safety risk situations for a road segment related to a dynamic construction event, autonomous vehicles may be in increased risk of a road accident or another safety event, thereby reducing performance and/or efficiency of the autonomous vehicles.

To address these and/or other issues, a method, apparatus and computer program product are provided in accordance with an example embodiment in order to define a geo-defense area related to presence of a roadworker entity. The geo-defense area can be a geofence area for a roadworker entity to minimize safety risk situations for vehicles such as, for example, autonomous vehicles, traveling along a road segment related to the geo-defense area. In one or more embodiments, the geo-defense area can be configured with a defined geometry, speed limit information, and/or a speed profile to facilitate navigation for vehicles such as, for example, autonomous vehicles, traveling along a road segment related to the geo-defense area. A speed profile can be a dynamic speed profile related to the road segment. Additionally, the speed profile can then be utilized by autonomous vehicles to facilitate autonomous driving via the road segment and/or a road network region that includes the road segment. In one or more embodiments, roadworker entity information including geo-defense area information can be aggregated into dynamic content feeds to be delivered to and/or utilized by a data consumer.

In one or more embodiments, aggregated vehicle probe data can be employed to detect a roadwork event related to a roadwork zone region of a road segment. A roadwork event can be an event related to construction, road work, road maintenance, and/or another safety risk situation related to a road segment where one or more roadworker entities are likely present. A roadwork zone region can be a portion of the road segment and/or an area related to the road segment where the roadwork event occurs. The aggregated vehicle probe data can include sensor data and/or other connected-vehicle data such as, but not limited to, location data (e.g., geolocation data, global positioning system (GPS) data, etc.), anti-lock braking system (ABS) data, headlight data, windshield wiper data, video sensor data (e.g., video camera data), image sensor data (e.g., image camera data), brake pressure data, fog light data, ignition data, hazard light data, ultrasonic sensor data, LiDAR sensor data, radar sensor data, communication network data (e.g., 5G coverage data), and/or other in-vehicle sensor data.

In one or more embodiments, presence of one or more roadworker entities within the roadwork zone region can be detected based on sensor data and/or edge computing technology related to one or more vehicles (e.g., one or more autonomous vehicles) traveling along the road segment at least proximate to the roadwork zone region. Additionally, roadwork data related to the roadwork zone region and/or location data related to the one or more roadworker entities can be employed to retrieve map data (e.g., high-definition (HD) map data) related to the roadwork zone region. The location data related to the one or more roadworker entities can then be map matched to the map data to determine a geo-defense area related to the one or more roadworker entities.

In one or more embodiments, the geo-defense area can be utilized by autonomous vehicles to configure a speed setting for the autonomous vehicles (e.g., set a minimum speed limit and/or a maximum speed limit for autonomous driving), initiate a lane change along the road segment for the autonomous vehicles, determine a navigation route along the road segment for the autonomous vehicles, configure an autonomous driving level (e.g., alter an autonomous driving level) for the autonomous vehicles, enable/disable autonomous driving in the geo-defense area, etc. In one or more embodiments, one or more notifications (e.g., a warning message) can be generated based on the geo-defense area and the one or more notifications can be presented via a display (e.g., a navigation system) of one or more vehicles (e.g., one or more autonomous vehicles). According to one or more embodiments, information related to the geo-defense area and/or the speed limit information can be uploaded to a mapping server. In certain embodiments, information related to the geo-defense area and/or the speed limit information can be mapped onto a road network and/or a road lane network.

Accordingly, a geo-defense area and/or related information can be provided for a road segment (and/or a road network region that includes the road segment and one or more other road segments) during safety risk situations for the road segment. Furthermore, vehicle accident risks for autonomous vehicle traveling along a road segment can be mitigated during safety risk situations for the road segment. Moreover, autonomous vehicles can be managed to provide improved autonomous driving and/or vehicle localization for a vehicle traveling along a road segment or a road network region. Moreover, autonomous vehicles can be managed to provide additional dimensionality and/or advantages for one or more sensors of a vehicle. Autonomous vehicles can also be managed to provide a low cost and/or efficient solution for improved autonomous driving and/or vehicle localization for a vehicle. Computational resources for improved autonomous driving and/or vehicle localization can also be conserved. Autonomous vehicles can also be managed to provide a cost effective and/or efficient solution for improved autonomous driving and/or vehicle localization. Computational resources for improved autonomous driving and/or vehicle localization by utilizing speed profiles for autonomous vehicles as disclosed herein can also be relatively limited in order to allow the computational resources to be utilized for other purposes. Utilizing speed profiles for autonomous vehicles as disclosed herein may additionally facilitate improved navigation of a vehicle, improved route guidance for a vehicle, improved semi-autonomous vehicle control, and/or improved fully autonomous vehicle control.

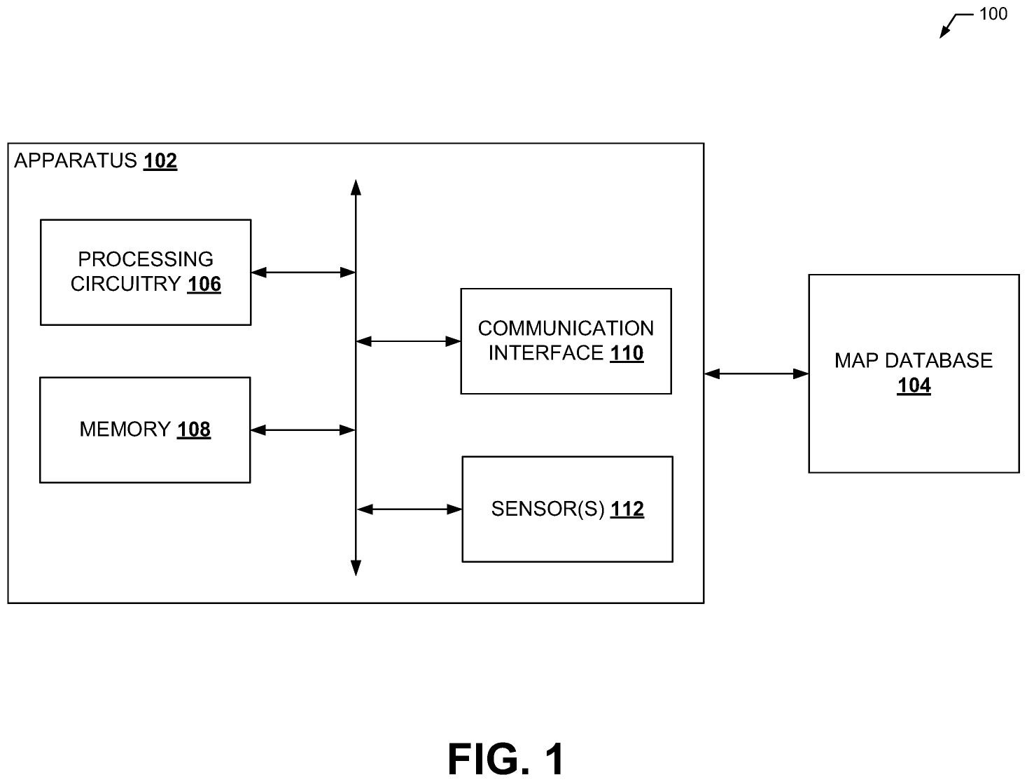

With reference to FIG. 1, a system 100 configured to define a geo-defense area related to presence of a roadworker entity is depicted, in accordance with one or more embodiments of the present disclosure. In the illustrated embodiment, the system 100 includes an apparatus 102 and a map database 104. As described further below, the apparatus 102 is configured in accordance with an example embodiment of the present disclosure to assist navigation of a vehicle and/or to autonomous driving for a vehicle. The apparatus 102 can be embodied by any of a wide variety of computing devices including, for example, a computer system of a vehicle, a vehicle system of a vehicle, a navigation system of a vehicle, a control system of a vehicle, an electronic control unit of a vehicle, an autonomous vehicle control system (e.g., an autonomous-driving control system) of a vehicle, a mapping system of a vehicle, an ADAS of a vehicle, or any other type of computing device carried by or remote from the vehicle including, for example, a server or a distributed network of computing devices.

In an example embodiment where some level of vehicle autonomy is involved, the apparatus 102 can be embodied or partially embodied by a computing device of a vehicle that supports safety-critical systems such as the powertrain (engine, transmission, electric drive motors, etc.), steering (e.g., steering assist or steer-by-wire), and/or braking (e.g., brake assist or brake-by-wire). However, as certain embodiments described herein may optionally be used for map generation, map updating, and map accuracy confirmation, other embodiments of the apparatus may be embodied or partially embodied as a mobile terminal, such as a personal digital assistant (PDA), mobile telephone, smart phone, personal navigation device, smart watch, tablet computer, camera or any combination of the aforementioned and other types of voice and text communications systems. Regardless of the type of computing device that embodies the apparatus 102, the apparatus 102 of an example embodiment includes, is associated with or otherwise is in communication with processing circuitry 106, memory 108 and optionally a communication interface 110.

In some embodiments, the processing circuitry 106 (and/or co-processors or any other processors assisting or otherwise associated with the processing circuitry 106) can be in communication with the memory 108 via a bus for passing information among components of the apparatus 102. The memory 108 can be non-transitory and can include, for example, one or more volatile and/or non-volatile memories. In other words, for example, the memory 108 may be an electronic storage device (for example, a computer readable storage medium) comprising gates configured to store data (for example, bits) that can be retrievable by a machine (for example, a computing device like the processing circuitry 106). The memory 108 can be configured to store information, data, content, applications, instructions, or the like for enabling the apparatus 102 to carry out various functions in accordance with an example embodiment of the present disclosure. For example, the memory 108 can be configured to buffer input data for processing by the processing circuitry 106. Additionally or alternatively, the memory 108 can be configured to store instructions for execution by the processing circuitry 106.

The processing circuitry 106 can be embodied in a number of different ways. For example, the processing circuitry 106 may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry 106 can include one or more processing cores configured to perform independently. A multi-core processor can enable multiprocessing within a single physical package. Additionally or alternatively, the processing circuitry 106 can include one or more processors configured in tandem via the bus to enable independent execution of instructions, pipelining and/or multithreading.

In an example embodiment, the processing circuitry 106 can be configured to execute instructions stored in the memory 108 or otherwise accessible to the processing circuitry 106. Alternatively or additionally, the processing circuitry 106 can be configured to execute hard coded functionality. As such, whether configured by hardware or software methods, or by a combination thereof, the processing circuitry 106 can represent an entity (for example, physically embodied in circuitry) capable of performing operations according to an embodiment of the present disclosure while configured accordingly. Thus, for example, when the processing circuitry 106 is embodied as an ASIC, FPGA or the like, the processing circuitry 106 can be specifically configured hardware for conducting the operations described herein. Alternatively, as another example, when the processing circuitry 106 is embodied as an executor of software instructions, the instructions can specifically configure the processing circuitry 106 to perform the algorithms and/or operations described herein when the instructions are executed. However, in some cases, the processing circuitry 106 can be a processor of a specific device (for example, a computing device) configured to employ an embodiment of the present disclosure by further configuration of the processor by instructions for performing the algorithms and/or operations described herein. The processing circuitry 106 can include, among other things, a clock, an arithmetic logic unit (ALU) and/or one or more logic gates configured to support operation of the processing circuitry 106.

The apparatus 102 of an example embodiment can also optionally include the communication interface 110 that can be any means such as a device or circuitry embodied in either hardware or a combination of hardware and software that is configured to receive and/or transmit data from/to other electronic devices in communication with the apparatus 102, such as the map database 104 that stores data (e.g., map data, autonomous level data, vehicle context data, location data, geo-referenced locations, time data, timestamp data, temporal data, vehicle data, vehicle version data, software version data, hardware version data, vehicle speed data, distance data, statistical data, etc.) generated and/or employed by the processing circuitry 106. Additionally or alternatively, the communication interface 110 can be configured to communicate in accordance with various wireless protocols including Global System for Mobile Communications (GSM), such as but not limited to Long Term Evolution (LTE). In this regard, the communication interface 110 can include, for example, an antenna (or multiple antennas) and supporting hardware and/or software for enabling communications with a wireless communication network. In this regard, the communication interface 110 can include, for example, an antenna (or multiple antennas) and supporting hardware and/or software for enabling communications with a wireless communication network. Additionally or alternatively, the communication interface 110 can include the circuitry for interacting with the antenna(s) to cause transmission of signals via the antenna(s) or to handle receipt of signals received via the antenna(s). In some environments, the communication interface 110 can alternatively or also support wired communication and/or may alternatively support vehicle to vehicle or vehicle to infrastructure wireless links.

In certain embodiments, the apparatus 102 can be equipped or associated with one or more sensors 112, such as one or more geolocation sensors (e.g., one or more GPS sensors, one or more global navigation satellite system (GNSS) sensors, one or more Galileo sensors, one or more GLONASS sensors, one or more BeiDou sensors, etc.), one or more accelerometer sensors, one or more LiDAR sensors, one or more radar sensors, one or more gyroscope sensors, one or more ultrasonic sensors, one or more infrared sensors, one or more camera sensors, one or more in-vehicle sensors and/or one or more other sensors. Any of the one or more sensors 112 may be used to sense and/or obtain probe data (e.g., vehicle probe data) for use in navigation assistance and/or autonomous vehicle control, as described herein according to example embodiments.

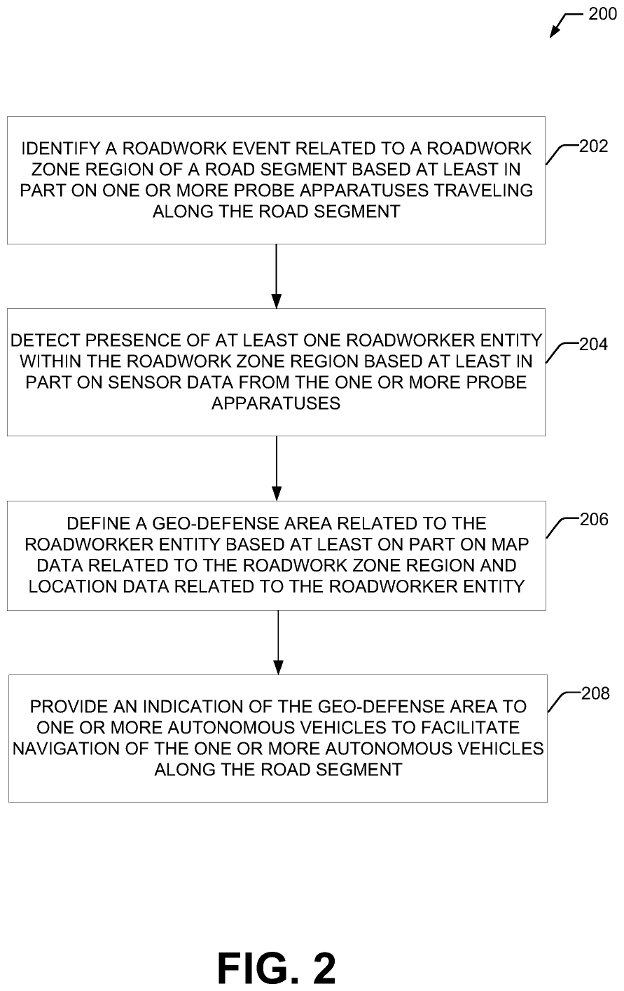

FIG. 2 illustrates a flowchart depicting a method 200 according to an example embodiment of the present disclosure. It will be understood that each block of the flowchart and combination of blocks in the flowchart can be implemented by various means, such as hardware, firmware, processor, circuitry, and/or other communication devices associated with execution of software including one or more computer program instructions. For example, one or more of the procedures described above can be embodied by computer program instructions. In this regard, the computer program instructions which embody the procedures described above can be stored, for example, by the memory 108 of the apparatus 102 employing an embodiment of the present disclosure and executed by the processing circuitry 106. As will be appreciated, any such computer program instructions can be loaded onto a computer or other programmable apparatus (for example, hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Autonomous driving has become a focus of recent technology with recent advances in machine learning, computer vision, and computing power able to conduct real-time mapping and sensing of a vehicle's environment. Such an understanding of the environment enables autonomous driving in two distinct ways. Primarily, real-time or near real-time sensing of the environment can provide information about potential obstacles, the behavior of others on the roadway, and areas that are navigable by the vehicle. An understanding of the location of other vehicles and/or what the other vehicles have done and may be predicted to do may be useful for a vehicle (or apparatus 102) to safely plan a route.

Autonomous vehicles or vehicles with some level of autonomous controls provide some degree of vehicle control that was previously performed by a person driving a vehicle. Removing some or all of the responsibilities of driving from a person and automating those responsibilities require a high degree of confidence in performing those responsibilities in a manner at least as good as a human driver. For example, maintaining a vehicle's position within a lane by a human involves steering the vehicle between observed lane markings and determining a lane when lane markings are faint, absent, or not visible due to weather (e.g., heavy rain, snow, bright sunlight, etc.). As such, it is desirable for the autonomous vehicle to be equipped with sensors sufficient to observe road features, and a controller that is capable of processing the signals from the sensors observing the road features, interpret those signals, and provide vehicle control to maintain the lane position of the vehicle based on the sensor data. Maintaining lane position is merely one illustrative example of a function of autonomous or semi-autonomous vehicles that demonstrates the sensor level and complexity of autonomous driving. However, autonomous vehicle capabilities, particularly in fully autonomous vehicles, must be capable of performing all driving functions. As such, the vehicles must be equipped with sensor packages that enable the functionality in a safe manner.

Referring now to FIG. 2, the operations performed, such as by the apparatus 102 of FIG. 1, in order to define a geo-defense area related to presence of a roadworker entity, in accordance with one or more embodiments of the present disclosure. As shown in block 202 of FIG. 2, the apparatus 102 includes means, such as the processing circuitry 106, the memory 108, or the like, configured to identify a roadwork event related to a roadwork zone region of a road segment based at least in part on one or more probe apparatuses traveling along the road segment. For example, the one or more probe apparatuses traveling along the road segment can determine and/or provide probe data, sensor data, and/or other data. Additionally, the apparatus 102, such as the processing circuitry 106, can be configured to identify the roadwork event based at least in part on the probe data, sensor data, and/or other data. The probe data can include aggregated probe data from the from one or more probe apparatuses. Additionally, the probe data can be vehicle probe data. For example, in one or more embodiments, the one or more probe apparatuses can be one or more data collection devices of one or more vehicles traveling along the road segment. In one or more embodiments, the probe data can include sensor data and/or other connected-vehicle data such as, but not limited to, location data (e.g., geolocation data, location probe data points, geo-referenced locations, GNSS probe data, GPS probe data, Galileo probe data, GLONASS probe data, BeiDou probe data, etc.), ABS data, headlight data, windshield wiper data, video camera data, image camera data, brake pressure data, fog light data, ignition data, hazard light data, ultrasonic sensor data, LiDAR sensor data, radar sensor data, communication network data (e.g., 5G communication network data, 6G communication network data), and/or other in-vehicle sensor data.

In one or more embodiments, the road segment can be a road segment that forms a portion of a road network region. For example, the road network region can include the road segment and one or more road segments. The roadwork event can be a dynamic construction event or another type of safety risk situation where autonomous vehicles or other vehicles may be in increased risk of a road accident or another safety event. For example, a roadwork event can be an event related to construction, road work, road maintenance, and/or another safety risk situation related to a road segment where one or more roadworker entities are likely present.

In one or more embodiments, the apparatus 102, such as the processing circuitry 106, can be configured to identify the roadwork event based at least in part on road condition data related to the road segment. The road condition data can be representative of one or more road conditions related to the road segment. The road condition data can include traffic incident data related to the road segment, hazard warning data related to the road segment, weather condition data related to the road segment, and/or map data (e.g., HD map data) related to the road segment. Accordingly, in one or more embodiments, the apparatus 102, such as the processing circuitry 106, can be configured to identify the roadwork event based at least in part on traffic incident data related to the road segment, hazard warning data related to the road segment, weather condition data related to the road segment, real-time traffic data related to the road segment, and/or map data (e.g., HD map data) related to the road segment.

In one or more embodiments, the traffic incident data can include information regarding one or more traffic incidents such as, for example, real-time traffic data related to the road segment, one or more traffic accidents related to the road segment, one or more traffic jams related to the road segment, one or more road construction incidents related to the road segment, one or more traffic light incidents related to the road segment, one or more high pedestrian traffic incidents related to the road segment, one or more traffic slowdown incidents related to the road segment, one or more real-time incidents related to the road segment, one or more video camera incidents related to one or more autonomous vehicles traveling along the road segment, one or more ultrasonic sensor incidents related to one or more autonomous vehicles traveling along the road segment, one or more ignition incidents related to one or more autonomous vehicles traveling along the road segment, one or more airbag incidents related to one or more autonomous vehicles traveling along the road segment, one or more break pressure incidents related to one or more autonomous vehicles traveling along the road segment, one or more crash response incidents related to one or more autonomous vehicles traveling along the road segment, and/or one or more other traffic incidents related to the road segment.

The hazard warning data can include information regarding one or more hazard warning conditions related to the road segment such as, for example, an ice warning condition related to the road segment, a heavy rain warning condition related to the road segment, a hydroplane warning condition related to the road segment, a fog warning condition related to the road segment, an ABS condition related to one or more autonomous vehicles traveling along the road segment, a headlight condition related to one or more autonomous vehicles traveling along the road segment, a windshield wiper condition related to one or more autonomous vehicles traveling along the road segment, a break pressure condition related to one or more autonomous vehicles traveling along the road segment, a fog light condition related to one or more autonomous vehicles traveling along the road segment, a hazard light condition related to one or more autonomous vehicles traveling along the road segment, a wireless network connection condition related to one or more autonomous vehicles traveling along the road segment, and/or one or more other hazard warning conditions related to the road segment.

The weather condition data can include real-time weather information related to a geographic location or geographic region for the road segment. For example, the weather condition data can include a real-time weather condition related to the geographic location or geographic region for the road segment, a real-time temperature reading related to the geographic location or geographic region for the road segment, a real-time precipitation condition related to the geographic location or geographic region for the road segment, a real-time wind condition related to the geographic location or geographic region for the road segment, a real-time humidity reading related to the geographic location or geographic region for the road segment, a real-time pressure condition related to the geographic location or geographic region for the road segment, a real-time ultraviolet index condition related to the geographic location or geographic region for the road segment, a real-time fog condition related to the geographic location or geographic region for the road segment, a real-time snow condition related to the geographic location or geographic region for the road segment, a real-time wind chill condition related to the geographic location or geographic region for the road segment, a real-time storm condition related to the geographic location or geographic region for the road segment, and/or one or more other real-time weather conditions related to a geographic location or geographic region for the road segment.

The map data can be map data (e.g., HD map data) stored in and/or obtained from a map database managed by a map service provider. The map data can include node data, road segment data, link data, point of interest (POI) data, historical road condition data, historical traffic data, lane marking data, autonomous driving data, and/or other map data related to the road segment. Additionally or alternatively, the map data can include information regarding a change in a driving mode related to an autonomous level for one or more autonomous vehicles traveling along the road segment. For example, the map data can store a reason for a change in a driving mode related to an autonomous level for one or more autonomous vehicles traveling along the road segment, a current autonomous level for one or more autonomous vehicles traveling along the road segment, a previous autonomous level for one or more autonomous vehicles traveling along the road segment, vehicle data for one or more autonomous vehicles traveling along the road segment, a vehicle identifier for one or more autonomous vehicles traveling along the road segment, and/or other data to facilitate autonomous driving for one or more autonomous vehicles traveling along the road segment.

As shown in block 204 of FIG. 2, the apparatus 102 additionally or alternatively includes means, such as the processing circuitry 106, the memory 108, or the like, configured to detect presence of at least one roadworker entity within the roadwork zone region based at least in part on sensor data from the one or more probe apparatuses. A roadworker entity can be a construction worker, management personnel, a field safety worker, or another type of roadworkers that is vulnerable to an incident with a vehicle such as, for example, an autonomous vehicle during the roadwork event. The sensor data can include data such as, but not limited to, location data (e.g., geolocation data, location probe data points, geo-referenced locations, GNSS probe data, GPS probe data, Galileo probe data, GLONASS probe data, BeiDou probe data, etc.), inertial sensor data, gyroscope sensor data, accelerometer sensor data, ABS data, headlight data, windshield wiper data, video camera data, image camera data, brake pressure data, fog light data, ignition data, hazard light data, ultrasonic sensor data, LiDAR sensor data, radar sensor data, communication network data (e.g., 5G communication network data, 6G communication network data), and/or other in-vehicle sensor data. In one or more embodiments, the apparatus 102, such as the processing circuitry 106, can be configured to detect presence of at least one roadworker entity within the roadwork zone region based at least in part on one or more machine learning techniques with respect to the sensor data. For example, at least a portion of the sensor data can be provided as input to a machine learning model configured for detecting presence of an object such as the at least one roadworker entity in image data, video data, LiDAR sensor data, radar sensor data, and/or other sensor data. The machine learning model can be neural network model, a convolutional neural network (CNN) model, a deep learning model, a deep neural network (DNN) model, and/or another type of machine learning model configured for providing predictions, inferences, and/or insights via machine learning processing.

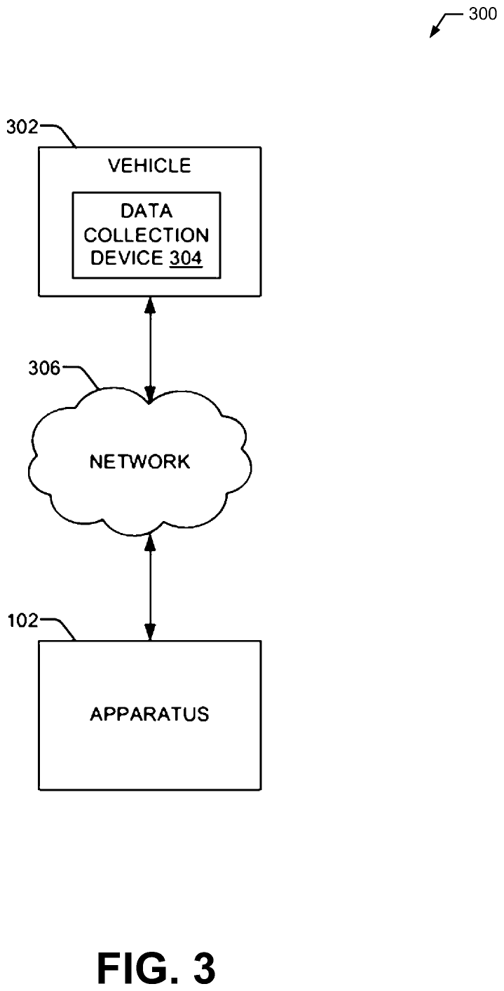

In one or more embodiments, the apparatus 102, such as the processing circuitry 106, can be configured to obtain sensor data from the one or more probe apparatuses traveling along the road segment. An example system 300 that includes a vehicle that generates at least a portion of the probe data and/or the sensor data associated with the road segment is depicted in FIG. 3. It is to be appreciated that the probe data and/or the sensor data can be anonymized without being correlated to the road segment. For example, correlation of particular probe data and/or sensor data with a specific road segment (e.g., via map matching) can occur after anonymization of the probe data and/or sensor data for use in data aggregation. The system includes a vehicle 302 and the apparatus 102. As shown in FIG. 3, the vehicle 302 includes a data collection device 304. The data collection device 304 can be configured to capture probe data and/or sensor data as the vehicle 302 travels along a road network. In an embodiment, the data collection device 304 can include one or more sensors from the one or more sensors 114. The data collection device 304 can be mounted, in an embodiment, within the vehicle 302, such as a component of a navigation system, an ADAS or the like. Alternatively, the data collection device 304 can be carried by a passenger within the vehicle 302, such as in an instance in which the data collection device 304 is embodied by mobile device, a smartphone, a tablet computer, a wearable device, a virtual reality device or another portable computing device carried by the passenger riding within the vehicle 302. In an aspect, the data collection device 304 can repeatedly capture at least a portion of the probe data as the data collection device 304 moves along the road network. For example, the data collection device 304 can capture at least a portion of the probe data and/or the sensor data at a defined frequency and/or at a defined sampling rate.

In certain embodiments, respective probe data (e.g., including, for example, respective sensor data) can define and/or be related to a location and/or a timestamp at which the respective probe data was captured. In an aspect, respective probe data can represent the location in terms of latitude and longitude associated with the road segment. Additionally or alternatively, respective probe data can be map matched so as to be associated with the road segment. Respective probe data can additionally be associated with a variety of other information including, for example, a speed of the vehicle 302 associated with capture of the respective probe data, acceleration of the vehicle 302 associated with capture of the respective probe data, a time at which the respective probe data was captured, an epoch at which the respective probe data was captured, a direction of travel of the vehicle 302 associated with capture of the respective probe data, a road lane in which the vehicle is traveling during capture of the respective probe data, an altitude of the vehicle 302 associated with capture of the respective probe data, a pitch of the vehicle 302 about a traverse axis associated with capture of the respective probe data, a vehicle type associated with the vehicle 302, other information associated with the vehicle 302, other information associated with capture of the respective probe data, etc.

As shown in block 206 of FIG. 2, the apparatus 102 additionally or alternatively includes means, such as the processing circuitry 106, the memory 108, or the like, configured to define a geo-defense area related to the roadworker entity based at least on part on map data related to the roadwork zone region and location data related to the roadworker entity. The geo-defense area can be a geofence area for a roadworker entity to minimize safety risk situations for vehicles such as, for example, autonomous vehicles, traveling along the road segment related to the geo-defense area. The map data can be map data (e.g., HD map data) stored in and/or obtained from a map database managed by a map service provider. The map data can include node data, road segment data, link data, POI data, historical road condition data, historical traffic data, lane marking data, autonomous driving data, and/or other map data related to the roadwork zone region. In one or more embodiments, the apparatus 102, such as the processing circuitry 106, can be configured to match the location data related to the roadworker entity to one or more portions of the map data. For example, the apparatus 102, such as the processing circuitry 106, can be configured to employ one or more map matching techniques related to logical model of the roadwork zone region to match the location data related to the roadworker entity to one or more portions of the map data.

In one or more embodiments, the apparatus 102, such as the processing circuitry 106, can be configured to employ image sensor data, video sensor data, and/or other sensor data (e.g., as captured by the data collection device 304) to identify the roadwork zone region. Additionally, the apparatus 102, such as the processing circuitry 106, can be configured to employ image sensor data, video sensor data, and/or other sensor data (e.g., as captured by the data collection device 304) to identify one or more objects and/or one or more entities within the roadwork zone region. For example, the one or more objects and/or the one or more entities within the roadwork zone region can include roadwork zone related equipment (e.g., cones, roadwork vehicles, roadwork equipment, roadwork tools, roadwork signs, etc.) and/or one or more roadworker entities. In one or more embodiments, the apparatus 102, such as the processing circuitry 106, can be configured to define the geo-defense area to include all roadwork zone related equipment, roadworker entity areas, and/or an additional buffer area with respect to the roadwork zone related equipment and/or the roadworker entity areas. In one or more embodiments, the apparatus 102, such as the processing circuitry 106, can be configured to determine location data related to the roadworker entity based on a geolocation device or another radio signal device equipped by the roadworker entity. For example, the location data can be determined based on a mobile device associated with the roadworker entity such as, for example, a personal navigation device (PND), a portable navigation device, a cellular telephone, a smart phone, a personal digital assistant (PDA), a watch, a camera, a computer, and/or other device that can perform geolocation-related functions. In one or more embodiments, the data collection device 304 of the vehicle 302 can detect the location data associated with the roadworker entity. Additionally or alternatively, the apparatus 102, such as the processing circuitry 106, can be configured to map match the location of the roadworker entity to a lane level of the road segment based on the location data. For example, the apparatus 102, such as the processing circuitry 106, can be configured to correlate the location data to road segment data of the road segment as included in map data such as, for example, HD map data related to the road segment.

In one or more embodiments, the apparatus 102, such as the processing circuitry 106, can be configured to define a geometry for the geo-defense area based at least on part on the map data related to the roadwork zone region and the location data related to the roadworker entity. For example, the apparatus 102, such as the processing circuitry 106, can be configured to define a size and/or a shape for the geo-defense area based at least on part on the map data related to the roadwork zone region and the location data related to the roadworker entity. Additionally or alternatively, the apparatus 102, such as the processing circuitry 106, can be configured to define a speed profile for the geo-defense area based at least on part on the map data related to the roadwork zone region and the location data related to the roadworker entity. The speed profile can model velocity of autonomous vehicles along the road segment. Additionally, the speed profile can then be utilized by autonomous vehicles to facilitate autonomous driving via the road segment and/or the geo-defense area. In one or more embodiments, the apparatus 102, such as the processing circuitry 106, can be configured to generate speed limit information (e.g., a minimum speed limit, a maximum speed limit, and/or a recommended speed) for the geo-defense area based at least on part on the map data related to the roadwork zone region and the location data related to the roadworker entity.

As shown in block 208 of FIG. 2, the apparatus 102 additionally or alternatively includes means, such as the processing circuitry 106, the memory 108, or the like, configured to provide an indication of the geo-defense area to one or more autonomous vehicles to facilitate navigation of the one or more autonomous vehicles along the road segment. In one embodiment, the apparatus 102, such as the processing circuitry 106, can be configured to configure a speed setting for the one or more autonomous vehicles based at least in part on the geo-defense area, the speed profile related to the geo-defense area, and/or the speed information related to the geo-defense area. For example, the apparatus 102, such as the processing circuitry 106, can be configured to configure a maximum speed setting, a minimum speed setting, and/or a recommended speed setting for the one or more autonomous vehicles based at least in part on the geo-defense area, the speed profile related to the geo-defense area, and/or the speed information related to the geo-defense area. In another embodiment, the apparatus 102, such as the processing circuitry 106, can be configured to initiate a lane change along the road segment for the one or more autonomous vehicles based at least in part on the geo-defense area, the speed profile related to the geo-defense area, and/or the speed information related to the geo-defense area. In another embodiment, the apparatus 102, such as the processing circuitry 106, can be configured to determine a navigation route along the road segment for the one or more autonomous vehicles based at least in part on the geo-defense area, the speed profile related to the geo-defense area, and/or the speed information related to the geo-defense area. In another embodiment, the apparatus 102, such as the processing circuitry 106, can be configured to configure an autonomous driving level for the one or more autonomous vehicles based at least in part on the geo-defense area, the speed profile related to the geo-defense area, and/or the speed information related to the geo-defense area. For example, the apparatus 102, such as the processing circuitry 106, can be configured to alter an autonomous driving level for the one or more autonomous vehicles to a different autonomous driving level based at least in part on the geo-defense area, the speed profile related to the geo-defense area, and/or the speed information related to the geo-defense area. In another example, the apparatus 102, such as the processing circuitry 106, can be configured to enable autonomous driving or disable autonomous driving for the one or more autonomous vehicles in the geo-defense area. In one or more embodiments, the apparatus 102, such as the processing circuitry 106, can be additionally alternatively configured to generating a notification (e.g., a warning message) for the one or more autonomous vehicles based at least in part on the geo-defense area. For example, the notification can be configured for a display and/or a navigation system of the one or more autonomous vehicles.

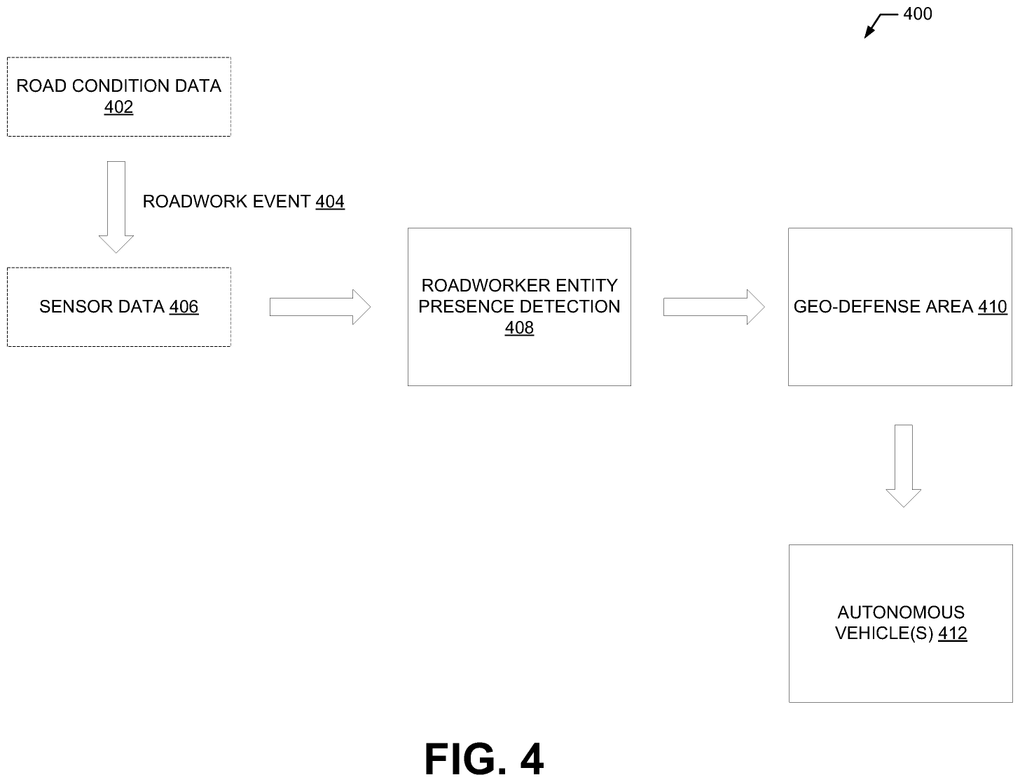

FIG. 4 illustrates an example geo-defense area generation process 400 according to one or more embodiments disclosed herein. As illustrated in FIG. 4, road condition data 402 configured as more fully disclosed herein can be employed to detect roadwork event 404 to initiate the apparatus 102, such as the processing circuitry 106, the memory 108, or the like, obtain sensor data 406 from one or more probe apparatuses (e.g., the data collection device 304) traveling along a road segment associated with roadwork event 404 as identified by the apparatus 102. Additionally, the apparatus 102, such as the processing circuitry 106, can be configured to provide roadworker entity presence detection 408 based at least in part on the sensor data 406. The apparatus 102, such as the processing circuitry 106, can additionally be configured to determine a geo-defense area 410 for the roadwork event 404 based at least in part on the roadworker entity presence detection 408. Moreover, the apparatus 102, such as the processing circuitry 106, can additionally be configured to provide an indication of the geo-defense area 410 to one or more autonomous vehicles 412 to facilitate navigation of the one or more autonomous vehicles 412 along the road segment and/or within the roadworker entity presence detection 408 related to the road segment.

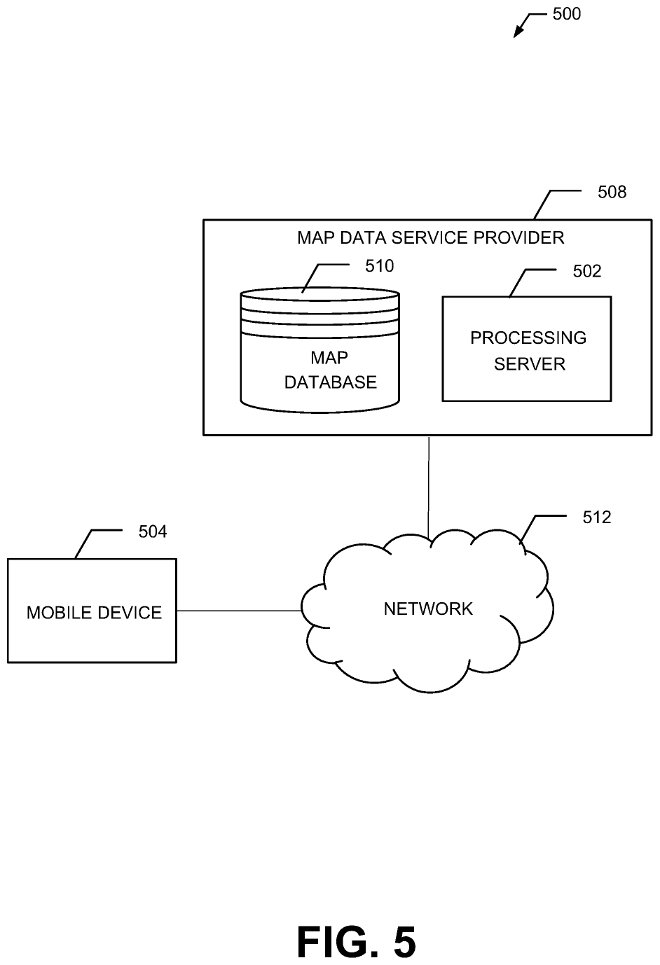

In certain embodiments, to facilitate navigation of one or more autonomous vehicles (e.g., the one or more autonomous vehicles 412), the apparatus 102 can support a mapping, navigation, and/or autonomous driving application so as to present maps or otherwise provide navigation or driver assistance, such as in an example embodiment in which map data is created or updated using methods described herein. For example, the apparatus 102 can provide for display of a map and/or instructions for following a route within a network of roads via a user interface (e.g., a graphical user interface). In order to support a mapping application, the apparatus 102 can include or otherwise be in communication with a geographic database, such as map database 104, a geographic database stored in the memory 108, and/or map database 510 shown in FIG. 5. For example, the geographic database can include node data records, road segment or link data records, POI data records, road lane marking records, and other data records. More, fewer or different data records can be provided. In one embodiment, the other data records include cartographic data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. Furthermore, other positioning technology can be used, such as electronic horizon sensors, radar, LiDAR, ultrasonic sensors and/or infrared sensors. In one or more embodiments, the other autonomous level data can be stored in the map database 104, the map database 510, and/or another database accessible by the apparatus 102.

In example embodiments, a navigation system user interface and/or an autonomous driving user interface can be provided to provide driver assistance to a user traveling along a network of roadways where data collected from the vehicle (e.g., the vehicle 302) associated with the navigation system user interface can aid in establishing a position of the vehicle along a road segment and/or can provide assistance for autonomous or semi-autonomous vehicle control of the vehicle. Autonomous vehicle control can include driverless vehicle capability where all vehicle functions are provided by software and hardware to safely drive the vehicle along a path identified by the vehicle. Semi-autonomous vehicle control can be any level of driver assistance from adaptive cruise control, to lane-keep assist, or the like. Establishing vehicle location and position along a road segment can provide information useful to navigation and autonomous or semi-autonomous vehicle control by establishing an accurate and highly specific position of the vehicle on a road segment and even within a lane of the road segment such that map features in the map, e.g., a high definition (HD) map, associated with the specific position of the vehicle can be reliably used to aid in guidance and vehicle control.

A map service provider database can be used to provide driver assistance, such as via a navigation system and/or through an ADAS having autonomous or semi-autonomous vehicle control features. Referring back to FIG. 5, illustrated is a communication diagram of an example embodiment of a system for implementing example embodiments described herein. The illustrated embodiment of FIG. 5 includes a mobile device 504, which can be, for example, the apparatus 102 of FIG. 1, such as a mobile phone, an in-vehicle navigation system, an ADAS, or the like. The illustrated embodiment of FIG. 5 also includes a map data service provider 508. The mobile device 504 and the map data service provider 508 can be in communication via a network 512. The network 512 can be any form of wireless or partially wireless network as will be described further below. Additional, different, or fewer components can be provided. For example, many mobile devices 504 can connect with the network 512. In an embodiment, the map data service provider can be a cloud service. For instance, in certain embodiments, the map data service provider 508 can provide cloud-based services and/or can operate via a hosting server that receives, processes, and provides data to other elements of the system 500.

The map data service provider 508 can include a map database 510 that can include node data, road segment data or link data, POI data, traffic data or the like. In one embodiment, the map database 510 can be different than the map database 104. In another embodiment, at least a portion of the map database 510 can correspond to the map database 104. The map database 510 can also include cartographic data, routing data, and/or maneuvering data. According to some example embodiments, the road segment data records can be links or segments representing roads, streets, or paths, as can be used in calculating a route or recorded route information for determination of one or more personalized routes. The node data can be end points corresponding to the respective links or segments of road segment data. The road link data and the node data can represent a road network, such as used by vehicles, cars, trucks, buses, motorcycles, and/or other entities. Optionally, the map database 510 can contain path segment and node data records or other data that can represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 510 can include data about the POIs and their respective locations in the POI records. The map database 510 can include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 510 can include event data (e.g., roadwork events, traffic incidents, construction activities, scheduled events, unscheduled events, etc.) associated with the POI data records or other records of the map database 510.

The map database 510 can be maintained by the map data service provider 508 and can be accessed, for example, by a processing server 502 of the map data service provider 508. By way of example, the map data service provider 508 can collect geographic data and/or dynamic data to generate and enhance the map database 510. In one example, the dynamic data can include traffic-related data. There can be different ways used by the map data service provider 508 to collect data. These ways can include obtaining data from other sources, such as municipalities or respective geographic authorities, such as via global information system databases. In addition, the map data service provider 508 can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that can be available is vehicle data provided by vehicles, such as provided, e.g., as probe points, by mobile device 504, as they travel the roads throughout a region.

In certain embodiments, at least a portion of the map database 104 can be included in the map database 510. In an embodiment, the map database 510 can be a master map database, such as an HD map database, stored in a format that facilitates updates, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems. For example, geographic data can be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device 504, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map database 510 of the map data service provider 508 can be a master geographic database, but in alternate embodiments, a client side map database can represent a compiled navigation database that can be used in or with end user devices (e.g., mobile device 504) to provide navigation and/or map-related functions. For example, the map database 510 can be used with the mobile device 504 to provide an end user with navigation features. In such a case, the map database 510 can be downloaded or stored on the end user device which can access the map database 510 through a wireless or wired connection, such as via a processing server 502 and/or the network 512, for example.

In one embodiment, as noted above, the end user device or mobile device 504 can be embodied by the apparatus 102 of FIG. 1 and can include an ADAS which can include an infotainment in-vehicle system or an in-vehicle navigation system, and/or devices such as a PND, a portable navigation device, a cellular telephone, a smart phone, a PDA, a watch, a camera, a computer, a server and/or other device that can perform navigation-related functions, such as digital routing and map display. An end user can use the mobile device 504 for navigation and map functions such as guidance and map display, for example, and for determination of useful driver assistance information, according to some example embodiments.

In one or more embodiments, the apparatus 102, such as the processing circuitry 106, can be additionally or alternatively configured to facilitate routing of the one or more autonomous vehicles along the road segment based on the geo-defense area. In one or more embodiments, the apparatus 102, such as the processing circuitry 106, can be additionally or alternatively configured to facilitate routing of the one or more autonomous vehicles along the road segment based on user feedback provided in response to an indication of the geo-defense area, speed information and/or an autonomous level being provided to a user interface display of the one or more autonomous vehicles along the road segment. In certain embodiments, the apparatus 102, such as the processing circuitry 106, can be configured to map the geo-defense area, the speed profile related to the geo-defense area, the speed information included in the speed profile, and/or other related to the geo-defense area onto one or more map data layers of a map (e.g., an HD map) to facilitate the autonomous driving for the one or more autonomous vehicles. For instance, in certain embodiments, the apparatus 102, such as the processing circuitry 106, can be configured to store the geo-defense area, the speed profile related to the geo-defense area, the speed information included in the speed profile, and/or other related to the geo-defense area in a map data layer of a map (e.g., an HD map) for mapping purposes, navigation purposes, and/or autonomous driving purposes associated with the road segment. In certain embodiments, the apparatus 102, such as the processing circuitry 106, can be configured to link and/or associate the geo-defense area, the speed profile related to the geo-defense area, the speed information included in the speed profile, and/or other related to the geo-defense area with one or more portions, components, areas, layers, features, text, symbols, and/or data records of a map (e.g., an HD map) associated with the road segment. In one or more embodiments, the apparatus 102, such as the processing circuitry 106, can be configured to generate a data point for a map layer associated with the road segment based on the geo-defense area, the speed profile related to the geo-defense area, the speed information included in the speed profile, and/or other related to the geo-defense area. The data point can indicate recommended speed information for autonomous vehicles. Additionally or alternatively, in one or more embodiments, the apparatus 102, such as the processing circuitry 106, can be configured to store the data point in the database associated with a map layer associated with the road segment.

In one or more embodiments, the apparatus 102, such as the processing circuitry 106, can be configured to generate one or more road links (e.g., one or more map-matched road links) for the geo-defense area, the speed profile related to the geo-defense area, the speed information included in the speed profile, and/or other related to the geo-defense area to facilitate an autonomous level prediction for autonomous vehicles. For instance, in one or more embodiments, the apparatus 102, such as the processing circuitry 106, can be configured to map the geo-defense area, the speed profile related to the geo-defense area, the speed information included in the speed profile, and/or other related to the geo-defense area onto a road network map associated with the road segment. In one or more embodiments, one or more notifications can be provided to a display of one or more autonomous vehicles based on the geo-defense area, the speed profile related to the geo-defense area, the speed information included in the speed profile, and/or other related to the geo-defense area.

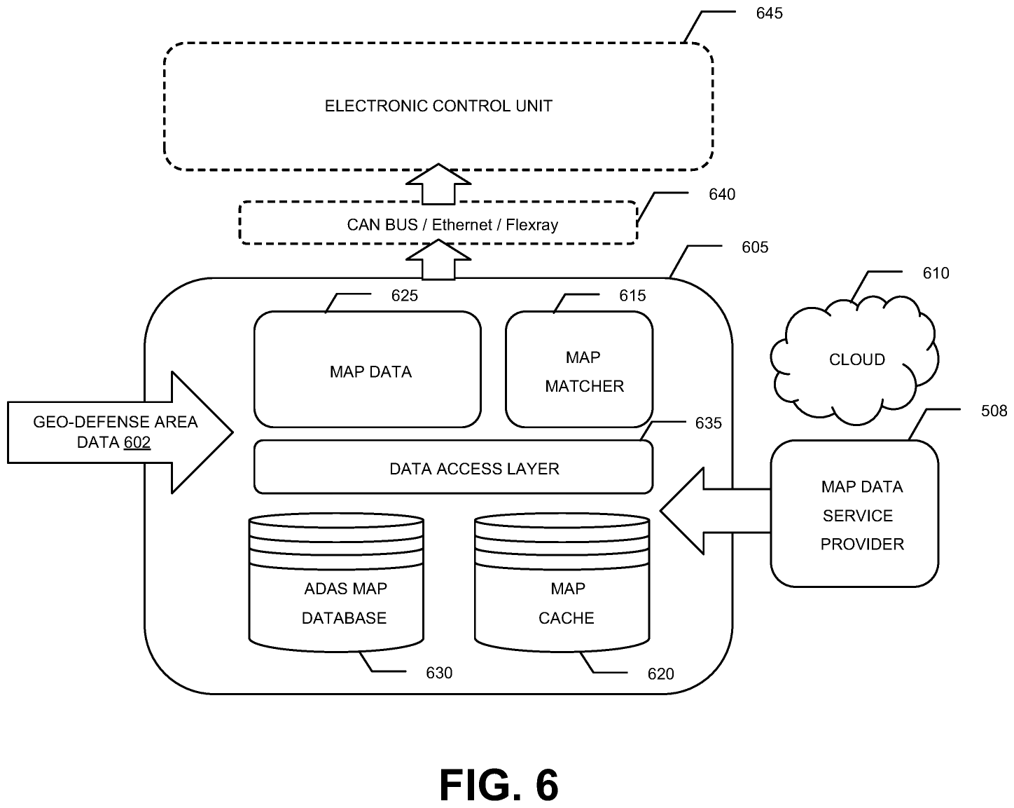

FIG. 6 illustrates an example embodiment of an architecture specifically configured for implementing embodiments described herein. The illustrated embodiment of FIG. 6 may be vehicle-based, where geo-defense area data 602 is determined for one or more autonomous vehicles (e.g., the one or more autonomous vehicles 412) traveling along a road segment. The geo-defense area data 602 can be data related to a geo-defense area of a road segment associated with roadwork event and/or one or more roadworker entities. Additionally, the geo-defense area data 602 can be associated with a speed profile, speed information included in the speed profile, and/or other data associated with a geo-defense area. Additionally or alternatively, in one or more embodiments, autonomous level data, location data and/or other data can be obtained from vehicles to facilitate autonomous driving. In one or more embodiments, location data associated with one or vehicles can be obtained from the one or more autonomous vehicles using GPS or other localization techniques. According to one or more embodiments, the geo-defense area data 602 can be correlated to map data of the map data service provider 508. A vehicle with autonomous or semi-autonomous control may establish improved speed recommendations and/or improved autonomous driving functionality through the geo-defense area data 602 to facilitate the autonomous or semi-autonomous control.

As illustrated in FIG. 6, the architecture includes the map data service provider 508 that provides map data 625 (e.g., HD maps and policies associated with road links within the map) to an Advanced Driver Assistance System (ADAS) 605, which may be vehicle-based or server based depending upon the application. The map data service provider 508 may be a cloud-based 610 service. In one or more embodiments, the ADAS 605 receives the geo-defense area data 602 and may provide the geo-defense area data 602 to map matcher 615. The map matcher 615 may correlate the geo-defense area data 602 to a road link on a map of the mapped network of roads stored in the map cache 620. This link or segment, along with the direction of travel, may be used to establish which HD map policies are applicable to the vehicle associated with the ADAS 605, including sensor capability information, autonomous functionality information, etc. Accordingly, in one or more embodiments, policies for the vehicle are established based on the geo-defense area data 602. The map data 625 associated with the road segment specific to the vehicle are provided to the vehicle control, such as via the CAN (computer area network) BUS (or Ethernet or Flexray) 640 to the electronic control unit (ECU) 645 of the vehicle to implement HD map policies, such as various forms of autonomous or assisted driving, or navigation assistance. In certain embodiments, a data access layer 635 can manage and/or facilitate access to the map cache 620, the map data 625, and/or an ADAS map database 630. In an embodiment, at least a portion of the ADAS map database 630 can correspond to the map database 104 and/or the map database 510.

By employing managing autonomous vehicles in accordance with one or more example embodiments of the present disclosure, precision and/or confidence of vehicle localization, vehicle speed settings, and/or autonomous driving for a vehicle can be improved. Furthermore, by managing autonomous vehicles in accordance with one or more example embodiments of the present disclosure, improved navigation of a vehicle can be provided, improved route guidance for a vehicle can be provided, improved semi-autonomous vehicle control can be provided, improved fully autonomous vehicle control can be provided, and/or improved safety of a vehicle can be provided. Moreover, in accordance with one or more example embodiments of the present disclosure, efficiency of an apparatus including the processing circuitry can be improved and/or the number of computing resources employed by processing circuitry can be reduced. In one or more embodiments, by managing autonomous vehicles in accordance with one or more example embodiments of the present disclosure, improved statistical information for a road segment can be provided to provide improved recommendations for infrastructure improvements.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Furthermore, in some embodiments, additional optional operations can be included. Modifications, additions, or amplifications to the operations above can be performed in any order and in any combination.

Moreover, although the foregoing descriptions and the associated drawings describe example embodiments in the context of certain example combinations of elements and/or functions, it should be appreciated that different combinations of elements and/or functions can be provided by alternative embodiments without departing from the scope of the appended claims. In this regard, for example, different combinations of elements and/or functions than those explicitly described above are also contemplated as can be set forth in some of the appended claims. Although specific terms are employed herein, they are used in a generic and descriptive sense only and not for purposes of limitation.

What is claimed is:

1. A computer-implemented method for defining a geo-defense area related to presence of a roadworker entity, the computer-implemented method comprising:
identifying a roadwork event related to a roadwork zone region of a road segment based at least in part on one or more probe apparatuses traveling along the road segment;
detecting presence of at least one roadworker entity within the roadwork zone region based at least in part on sensor data from the one or more probe apparatuses;
defining a geo-defense area related to the roadworker entity based at least on part on map data related to the roadwork zone region and location data related to the roadworker entity; and
providing an indication of the geo-defense area to one or more autonomous vehicles to facilitate navigation of the one or more autonomous vehicles along the road segment.

2. The computer-implemented method of claim 1, wherein identifying the roadwork event comprises identifying the roadwork event based at least in part on road condition data related to the road segment.

3. The computer-implemented method of claim 1, wherein identifying the roadwork event comprises identifying the roadwork event based at least in part on traffic incident data related to the road segment.

4. The computer-implemented method of claim 1, wherein identifying the roadwork event comprises identifying the roadwork event based at least in part on hazard warning data related to the road segment.

5. The computer-implemented method of claim 1, wherein identifying the roadwork event comprises identifying the roadwork event based at least in part on weather condition data related to the road segment.

6. The computer-implemented method of claim 1, wherein identifying the roadwork event comprises identifying the roadwork event based at least in part on high-definition (HD) map data related to the road segment.

7. The computer-implemented method of claim 1, wherein defining the geo-defense area comprises defining a geometry for the geo-defense area based at least on part on the map data related to the roadwork zone region and the location data related to the roadworker entity.

8. The computer-implemented method of claim 1, wherein defining the geo-defense area comprises defining a speed profile for the geo-defense area based at least on part on the map data related to the roadwork zone region and the location data related to the roadworker entity.

9. The computer-implemented method of claim 1, wherein defining the geo-defense area comprises defining speed limit information for the geo-defense area based at least on part on the map data related to the roadwork zone region and the location data related to the roadworker entity.

10. The computer-implemented method of claim 1, further comprising:
generating a notification for the one or more autonomous vehicles based at least in part on the geo-defense area.

11. The computer-implemented method of claim 1, further comprising:
determining a navigation route along the road segment for the one or more autonomous vehicles based at least in part on the geo-defense area.

12. The computer-implemented method of claim 1, further comprising:
configuring an autonomous driving level for the one or more autonomous vehicles based at least in part on the geo-defense area.

13. An apparatus comprising processing circuitry and at least one memory including computer program code instructions, the computer program code instructions configured to, when executed by the processing circuitry, cause the apparatus to:
identify a roadwork event related to a roadwork zone region of a road segment based at least in part on one or more probe apparatuses traveling along the road segment;
detect presence of at least one roadworker entity within the roadwork zone region based at least in part on sensor data from the one or more probe apparatuses;
define a geo-defense area related to the roadworker entity based at least on part on map data related to the roadwork zone region and location data related to the roadworker entity; and
provide an indication of the geo-defense area to one or more autonomous vehicles to facilitate navigation of the one or more autonomous vehicles along the road segment.

14. The apparatus according to claim 12, wherein the computer program code instructions are configured to, when executed by the processing circuitry, cause the apparatus to:
identify the roadwork event based at least in part on road condition data related to the road segment.

15. The apparatus according to claim 12, wherein the computer program code instructions are configured to, when executed by the processing circuitry, cause the apparatus to:
identify the roadwork event based at least in part on traffic incident data related to the road segment.

16. The apparatus according to claim 12, wherein the computer program code instructions are configured to, when executed by the processing circuitry, cause the apparatus to:
identify the roadwork event based at least in part on hazard warning data related to the road segment.

17. The apparatus according to claim 12, wherein the computer program code instructions are configured to, when executed by the processing circuitry, cause the apparatus to:
define a geometry for the geo-defense area based at least on part on the map data related to the roadwork zone region and the location data related to the roadworker entity.

18. The apparatus according to claim 12, wherein the computer program code instructions are configured to, when executed by the processing circuitry, cause the apparatus to:
define a speed profile for the geo-defense area based at least on part on the map data related to the roadwork zone region and the location data related to the roadworker entity.

19. The apparatus according to claim 12, wherein the computer program code instructions are configured to, when executed by the processing circuitry, cause the apparatus to:
define speed limit information for the geo-defense area based at least on part on the map data related to the roadwork zone region and the location data related to the roadworker entity.

20. A computer program product comprising at least one non-transitory computer-readable storage medium having computer-executable program code instructions stored therein, the computer-executable program code instructions comprising program code instructions to:
identify a roadwork event related to a roadwork zone region of a road segment based at least in part on one or more probe apparatuses traveling along the road segment;
detect presence of at least one roadworker entity within the roadwork zone region based at least in part on sensor data from the one or more probe apparatuses;
define a geo-defense area related to the roadworker entity based at least on part on map data related to the roadwork zone region and location data related to the roadworker entity; and
provide an indication of the geo-defense area to one or more autonomous vehicles to facilitate navigation of the one or more autonomous vehicles along the road segment.
